(19) United States
(12) Patent Application Publication
(10) Pub. No.: US 2021/0382784 A1
(43) Pub. Date: Dec. 9, 2021

(54) PROCESSING DEVICE, NON-TRANSITORY STORAGE MEDIUM, AND SYSTEM

(71) Applicant: KABUSHIKI KAISHA TOKAI RIKA DENKI SEISAKUSHO, Aichi (JP)

(72) Inventors: Takanori MATSUYAMA, Aichi (JP); Yosuke HASEGAWA, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/246,994

(22) Filed: May 3, 2021

(30) Foreign Application Priority Data
Jun. 4, 2020 (JP) 2020-097778

(51) Int. Cl. G06F 11/10; G06F 11/08

(52) U.S. Cl. CPC G06F 11/1048; G06F 11/1004; G06F 11/085

(57) ABSTRACT

There is provided a processing device to which different unique constants are allocated among devices of the same type, the processing device comprising: a processing unit that performs a calculation based on a common code that is issued by a code issuing device and is used in common by the plurality of processing devices, and the specific constant allocated to the processing device, and executes a subsequent process using a result of the calculation, wherein, prior to the subsequent process, the processing unit executes a determination of whether or not each of a result of a calculation based on the specific constant allocated to the processing device and a result of a calculation based on the specific constant allocated to at least one other processing device is a valid value.

### CROSS REFERENCE TO RELATED APPLICATION(S)

This application is based upon and claims benefit of priority from Japanese Patent Application No. 2020-097778, filed on Jun. 4, 2020, the entire contents of which are incorporated herein by reference.

### BACKGROUND

The present invention relates to a processing device, a non-transitory storage medium, and a system.

In recent years, many systems that operate through cooperation of a plurality of devices have been developed. For example, Japanese Unexamined Patent Application Publication No. 2019-193112 discloses a system including a master and a plurality of slaves.

### SUMMARY

However, in the above-described system, when an error occurs in any device in a case where a plurality of devices sequentially perform processes, there is a problem in that processes performed by other devices before the occurrence of the error may be wasted or the devices may be required to be restored to a state before execution of the processes.

Therefore, the present invention has been made in view of this problem, and an object of the present invention is to provide a structure capable of more reliably completing a series of processes performed by a plurality of devices.

To solve the above described problem, according to an aspect of the present invention, there is provided a processing device to which different unique constants are allocated among devices of the same type, the processing device comprising: a processing unit that performs a calculation based on a common code that is issued by a code issuing device and is used in common by the plurality of processing devices, and the specific constant allocated to the processing device, and executes a subsequent process using a result of the calculation, wherein, prior to the subsequent process, the processing unit executes a determination of whether or not each of a result of a calculation based on the specific constant allocated to the processing device and a result of a calculation based on the specific constant allocated to at least one other processing device is a valid value.

To solve the above described problem, according to another aspect of the present invention, there is provided a non-transitory storage medium storing a program causing a computer to function as a processing device to which different unique constants are allocated among devices of the same type, the program causing the processing device to: realize a processing function of performing a calculation based on a common code that is issued by a code issuing device and is used in common by the plurality of processing devices, and the specific constant allocated to the processing device, and executing a subsequent process using a result of the calculation, wherein the processing function is a function of, prior to the subsequent process, executing a determination of whether or not each of a result of a calculation based on the specific constant allocated to the processing device and a result of a calculation based on the specific constant allocated to at least one other processing device is a valid value.

To solve the above described problem, according to another aspect of the present invention, there is provided a system comprising: a code issuing device that issues a common code that is used in common by a plurality of devices; and a plurality of processing device that perform a calculation based on the common code and a specific constant allocated to each of devices of the same type and execute a subsequent process using a result of the calculation, wherein, prior to the subsequent process, at least one of the plurality of processing devices executes a determination of whether or not each of a result of a calculation based on the specific constant allocated to the processing device and a result of a calculation based on the specific constant allocated to at least one other processing device is a valid value.

As described above, according to the present invention, it is possible to provide a structure capable of more reliably completing a series of processes performed by a plurality of devices.

### BRIEF DESCRIPTION OF THE DRAWINGS

FIG. 1 is a block diagram illustrating a configuration example of a system 1 according to an embodiment of the present invention.

FIG. 2 is a block diagram illustrating a configuration example of a code issuing device 10 according to the embodiment.

FIG. 3 is a block diagram illustrating a functional configuration example of a processing device 20 according to the embodiment.

FIG. 4 is a sequence diagram illustrating a flow of processes performed by a comparison target system 8.

FIG. 5 is a sequence diagram illustrating an example of a process flow of processes performed by the system 1 according to the embodiment of the present invention.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

«1.1. System Configuration Example»

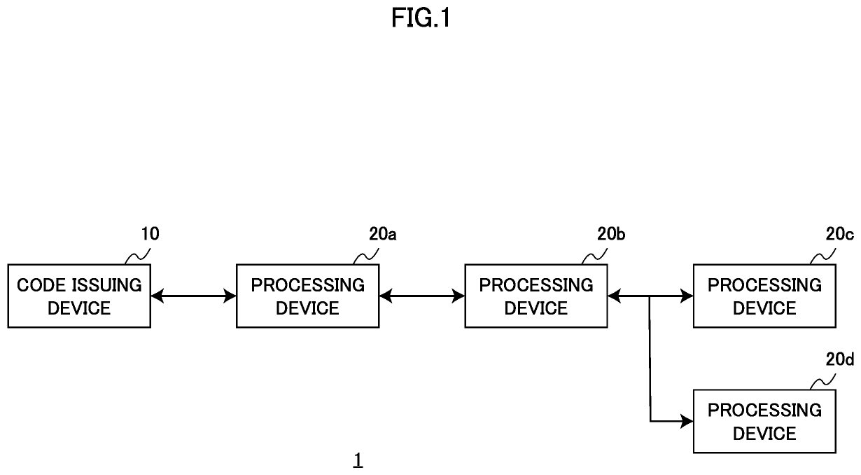

First, a configuration example of a system 1 according to an embodiment of the present invention will be described. FIG. 1 is a block diagram illustrating a configuration example of a system 1 according to an embodiment of the present invention. As illustrated in FIG. 1, the system 1 according to the present embodiment includes a code issuing device 10 and a plurality of processing devices 20.

(Code Issuing Device 10)

The code issuing device 10 according to the present embodiment is an information processing device that issues a common code that is used in common by the plurality of processing devices 20. The code issuing device 10 may operate as an information processing device that integrally controls the plurality of processing devices 20.

(Processing Device 20)

The processing device 20 according to the present embodiment is an information processing device that performs a calculation based on a common code issued by the code issuing device 10 and a specific constant that is allocated in advance, and executes a subsequent process using a result of the calculation. Different specific constants are respectively allocated to the plurality of processing devices 20 according to the present embodiment.

The processing device 20 according to the present embodiment may be an information processing device that executes various processes on the basis of the control of the code issuing device 10. Examples of the processing device 20 according to the present embodiment include a communication device performing wireless communication using, for example, an ultra-wide band (UWB) frequency.

FIG. 1 exemplifies a case where the system 1 according to the present embodiment includes four processing devices 20a to 20d, but the number of the processing devices 20 included in the system 1 according to the present embodiment is not limited to such an example. The system 1 according to the present embodiment may include two or more or any number of processing devices 20.

In the system 1 according to the present embodiment, each of the plurality of processing devices 20 is able to transmit information by being connected to at least one other processing device 20a.

For example, in the case of the example illustrated in FIG. 1, the processing device 20a is able to transmit information by being connected to the code issuing device 10 and the processing device 20b. In this case, the processing device 20a transmits information regarding, for example, the above-described common code acquired from the code issuing device 10 to the processing device 20b.

In the case of the example illustrated in FIG. 1, the processing device 20b is able to transmit information by being connected to the processing devices 20a, 20c, and 20d. In this case, the processing device 20b acquires information from the code issuing device 10 via the processing device 20a according to a data flow.

The processing device 20b transmits the information that is acquired from the code issuing device 10 via the processing device 20a to the processing devices 20c and 20d.

In other words, in the case of the example illustrated in FIG. 1, the processing device 20c acquires the information from the code issuing device 10 via the processing devices 20a and 20b according to the data flow.

Similarly, the processing device 20d acquires the information from the code issuing device 10 via the processing devices 20a and 20b according to the data flow.

As described above, each of the plurality of processing devices 20 according to the present embodiment can acquire the information from the code issuing device 10 directly or via other processing devices 20 and execute a process on the basis of the information.

The information transmission relationship between the plurality of processing devices 20 illustrated in FIG. 1 is only an example. In the system 1 according to the present embodiment, an information transmission relationship between the plurality of processing devices 20 may be freely configured.

For example, the plurality of processing devices 20 according to the present embodiment may be connected in series to each other to be able to transmit information.

As an example, in a case where the system 1 includes four processing devices 20a to 20d, information issued by the code issuing device 10 may be transmitted in an order of the processing devices 20a, 20b, 20c, and 20d.

For example, the plurality of processing devices 20 according to the present embodiment may be classified as a single processing device 20 that operates as a master on the basis of information that is directly acquired from the code issuing device 10 and other processing devices 20 that operate as slaves acquiring information from the code issuing device 10 via the processing device 20 operating as the master.

As an example, in a case where the system 1 includes four processing devices 20a to 20d, the processing device 20a that operates as a master may directly acquire information from the code issuing device 10, and each of the processing devices 20b to 20d that operate as slaves may acquire the information from the code issuing device 10 via the processing device 20a.

«1.2. Functional Configuration Example of Code issuing Device 10»

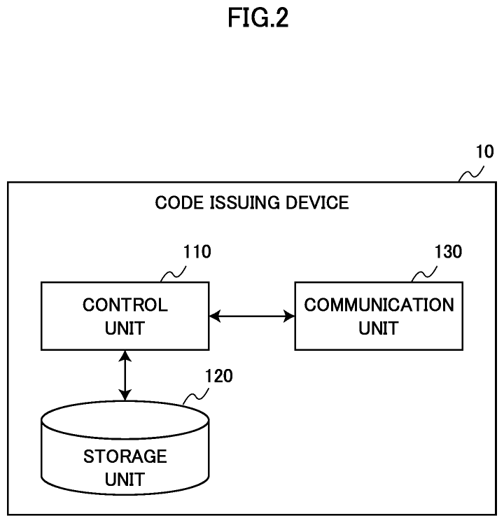

Next, a functional configuration example of the code issuing device 10 according to the present embodiment will be described. FIG. 2 is a block diagram illustrating a configuration example of the code issuing device 10 according to the present embodiment. As illustrated in FIG. 2, the code issuing device 10 according to the present embodiment includes at least a control unit 110, a storage unit 120, and a communication unit 130.

(Control Unit 110)

The control unit 110 according to the present embodiment performs various types of control related to the code issuing device 10 or the processing device 20. For example, the control unit 110 according to the present embodiment controls information transmission between the code issuing device 10 and the processing device 20 or collation of the processing device 20.

Functions of the control unit 110 are realized by various processors. Details of the functions of the control unit 110 according to the present embodiment will be described later.

(Storage Unit 120)

The storage unit 120 according to the present embodiment stores various pieces of information used for processes performed by the code issuing device 10. For example, the storage unit 120 stores various programs used in the control unit 110. The storage unit 120 stores the above common code.

(Communication Unit 130)

The communication unit 130 according to the present embodiment performs information communication with at least one processing device 20. For example, the communication unit 130 transmits the common code to at least one processing device 20. For example, the communication unit 130 receives a determination result based on the common code from at least one processing device 20.

The functional configuration example of the code issuing device 10 according to the present embodiment has been described above. The functional configuration described with reference to FIG. 2 is only an example, and a functional configuration of the code issuing device 10 according to the present embodiment is not limited to such an example. The functional configuration of the code issuing device 10 according to the present embodiment may be flexibly modified according to specifications or operations.

«1.3. Functional Configuration Example of Processing Device 20»

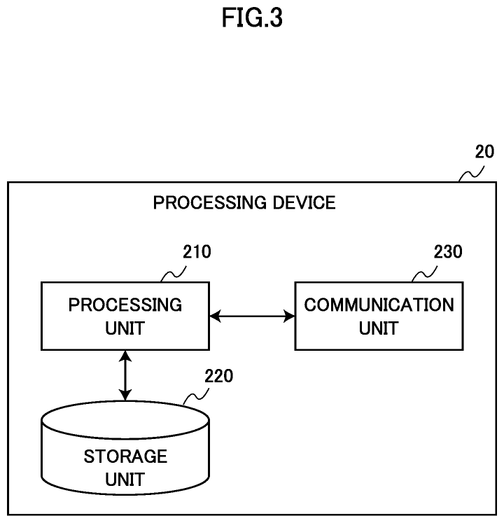

Next, a functional configuration example of the processing device 20 according to the present embodiment will be described. FIG. 3 is a block diagram illustrating a functional configuration example of the processing device 20 according to the present embodiment. As illustrated in FIG. 3, the processing device 20 according to the present embodiment includes at least a processing unit 210, a storage unit 220, and a communication unit 230.

(Processing Unit 210)

The processing unit 210 according to the present embodiment executes various processes on the basis of input information. For example, the processing unit 210 according to the present embodiment performs a calculation based on a common code that is issued by the code issuing device 10 and is used in common by the plurality of processing devices 20 and a specific constant that is allocated to the processing device 20, and executes a subsequent process using a result of the calculation.

The functions of the processing unit 210 are realized by various processors. Details of the processing unit 210 according to the present embodiment will be described later.

(Storage Unit 220)

The storage unit 220 according to the present embodiment stores various pieces of information used for processes performed by the processing device 20. For example, the storage unit 220 stores programs or the like used in the processing unit 210. The storage unit 220 stores the specific constant allocated to the processing device 20.

(Communication Unit 230)

The communication unit 230 according to the present embodiment performs information communication with at least one other processing device 20. For example, the communication unit 230 transmits information from the code issuing device 10 to at least one other processing device 20, or acquires the information from the code issuing device 10 via another processing device 20. The communication unit 230 according to the present embodiment may perform information communication with the code issuing device 10.

The functional configuration example of the processing device 20 according to the present embodiment has been described above. The functional configuration described with reference to FIG. 3 is only an example, and a functional configuration of the processing device 20 according to the present embodiment is not limited to such an example. The functional configuration of the processing device 20 according to the present embodiment may be flexibly modified according to specifications or operations.

«1.4. Flow of Processes»

Next, a flow of processes in the system 1 according to the present embodiment will be described in detail. In the system 1 according to the present embodiment, a common code issued by the code issuing device 10 is acquired by a plurality of processing devices 20 according to a data flow. Each processing device 20 performs a calculation based on the common code acquired according to the data flow and a specific constant that is allocated in advance, and executes a subsequent process using a result of the calculation.

Examples of the subsequent process include a registration process for performing a cooperative operation between the code issuing device 10 and the processing device 20.

More specifically, in a case where a result of a calculation based on the common code and the specific constant is a valid value satisfying a predefined condition, the plurality of processing devices 20 according to the present embodiment may execute the registration process for performing the cooperative operation.

According to such a flow of the processes, the plurality of processing devices 20 that have acquired information from the code issuing device 10 according to a data flow can sequentially execute the registration process, and thus processing efficiency can be improved as a whole.

However, as in the system 1 according to the present embodiment, in a system in which a plurality of devices sequentially executes processes, in a case where an error occurs in any device, there is a problem in that processes performed by other devices before the occurrence of the error may be wasted or the devices may be required to be restored to a state before execution of the processes.

Here, in order to describe features of the system 1 according to the present embodiment in detail, a flow of processes in a comparison target system 8 will be described first.

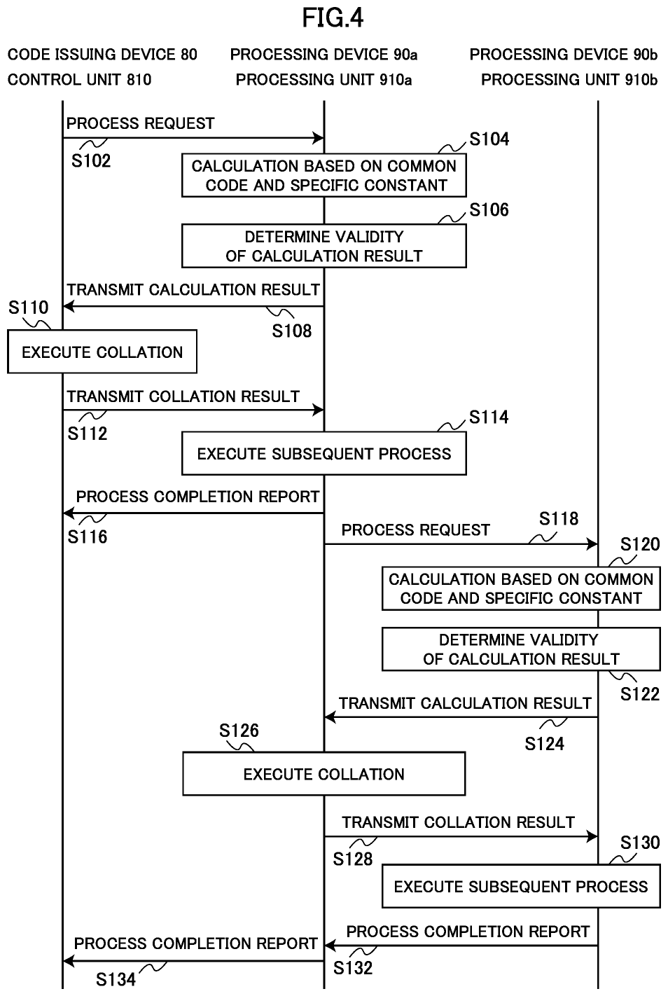

FIG. 4 is a sequence diagram illustrating a flow of processes in the comparison target system 8. In the example illustrated in FIG. 4, the comparison target system 8 includes a code issuing device 80 corresponding to the code issuing device 10 according to the present embodiment, and processing devices 90a and 90b corresponding to the processing devices 20 according to the present embodiment.

In the processes in the comparison target system 8, first, a process request including a common code is transmitted to the processing device 90a under the control of a control unit 810 of the code issuing device 80 (S102).

Next, a processing unit 910a of the processing device 90a receiving the process request in step S102 performs a calculation based on the common code included in the process request and a specific constant allocated to the processing device 90a (S104).

Next, the processing unit 910a of the processing device 90a determines the validity of the calculation result in step S104 (S106).

Here, in a case where the validity of the calculation result is recognized, the processing unit 910a of the processing device 90a performs control such that the calculation result in step S104 is transmitted to the code issuing device 80 (S108).

Next, the control unit 810 of the code issuing device 80 executes collation based on the process request transmitted in step S102 and the calculation result received in step S108 (S110).

Here, in a case where the consistency between both of the two is recognized as a result of the collation, the control unit 810 of the code issuing device 80 performs control such that the collation result indicating that the collation has been completed normally is transmitted to the processing device 90a (S112).

Next, the processing unit 910a of the processing device 90a executes a predetermined subsequent process on the basis of the collation result received in step S112 (S114).

Next, the processing unit 910a of the processing device 90a performs control such that a process completion report indicating that the subsequent process has been completed is transmitted to the code issuing device 80 (S116).

The processing unit 910a of the processing device 90a performs control such that the process request from the code issuing device 80 received in step S102 is transmitted to the processing device 90b (S118).

Next, a processing unit 910b of the processing device 90b receiving the process request in step S118 performs a calculation based on the common code included in the process request and a specific constant allocated to the processing device 90b (S120).

Next, the processing unit 910b of the processing device 90b determines the validity of the calculation result in step S120 (S122).

Here, in a case where the validity of the calculation result is recognized, the processing unit 910b of the processing device 90b performs control such that the calculation result in step S120 is transmitted to the processing device 90a (S124).

Next, the processing unit 910a of the processing device 90a executes collation based on the process request transmitted in step S118 and the calculation result received in step S124 (S126).

Here, in a case where the consistency between both of the two is recognized as a result of the collation, the processing unit 910a of the processing device 90a performs control such that the collation result indicating that the collation has been completed normally is transmitted to the processing device 90b. (S128).

Next, the processing unit 910b of the processing device 90b executes predetermined a subsequent process on the basis of the collation result received in step S128 (S130).

Next, the processing unit 910b of the processing device 90b performs control such that a process completion report indicating that the subsequent process has been completed is transmitted to the processing device 90a (S132).

The processing unit 910a of the processing device 90a performs control such that the process completion report received from the processing device 90b in step S132 is transmitted to the code issuing device 80 (S134).

As mentioned above, the flow of the processes in the comparison target system 8 has been described. In the above description, the case where the validity of both of calculation results in the processing devices 90a and 90b are recognized has been described.

However, here, in step S122, a case is assumed in which a calculation result in the processing device 90b is determined as not being valid. In this case, the subsequent process executed by the processing device 90a in step S114 are wasted, and thus the subsequent process is required to be executed again.

In a case where the subsequent process is a registration process for the cooperative operation, there is a case where the processing device 90a may be required to be replaced, processing efficiency may be reduced, and an operation load may increase.

The technical spirit according to the present disclosure was conceived by paying attention to the above points, and makes it possible to more reliably complete a series of processes performed by a plurality of devices. Thus, one feature of the processing unit 210 of at least one processing device 20 according to one embodiment of the present disclosure is to determine whether or not each of a result of a calculation based on a specific constant allocated to the processing device 20 and a result of a calculation based on a specific constant allocated to at least one other processing device 20 is a valid value, prior to the subsequent process.

Hereinafter, a flow of processes in the system 1 including the processing devices 20 having the above features will be described in detail.

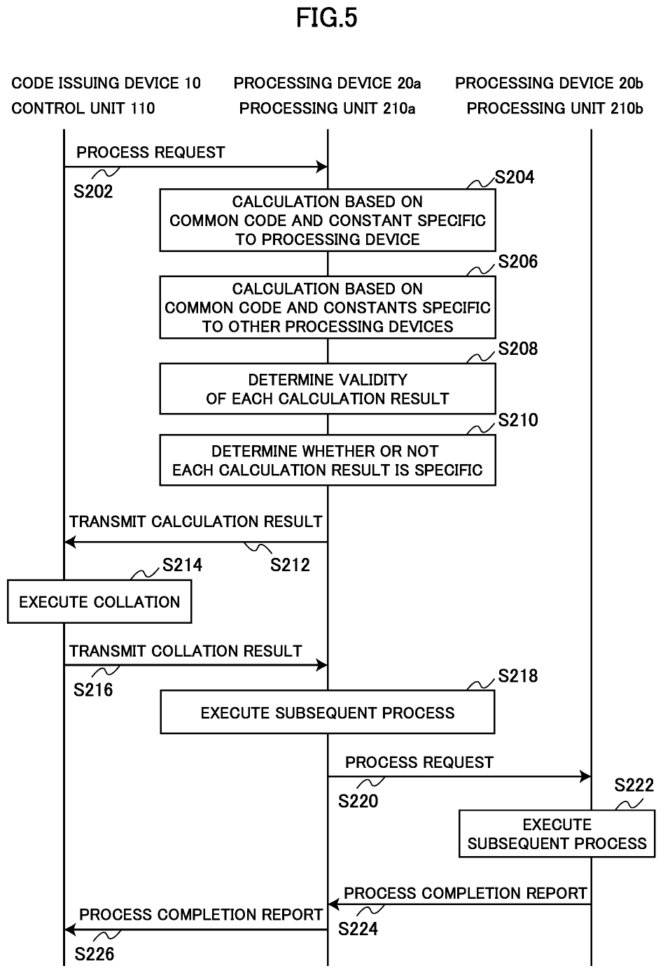

FIG. 5 is a sequence diagram illustrating an example of a process flow based on processes performed by the system 1 according to the present embodiment. In the example illustrated in FIG. 5, the system 1 includes the code issuing device 10 and two processing devices 20a and 20b.

In the processes in the system 1 according to the present embodiment, first, for example, a process request including a common code is transmitted to the processing device 20a under the control of the control unit 110 of the code issuing device 10 (S202).

Next, the processing unit 210a of the processing device 20a receiving the process request in step S202 performs a calculation based on the common code included in the process request and a specific constant allocated to the processing device 20a (S204).

Next, the processing unit 210a of the processing device 20a performs a calculation based on the common code and a constant specific to another processing device (S206). In other words, the processing unit 210a performs a calculation based on the common code and a specific constant allocated to the processing device 20b.

Next, the processing unit 210a of the processing device 20a determines the validity of each of the calculation results obtained in steps S204 and S206 (S208).

For example, in a case where a subsequent process is a registration process for the above-described cooperative operation, when the calculation results are all 0 or F, it may be determined that the calculation results are not valid. On the other hand, the above description is only an example, and an appropriate reference may be provided in relation to the validity of a calculation result.

Here, in a case where the validity of each calculation result is recognized, subsequent, the processing unit 210a of the processing device 20a determines whether or not each calculation result is specific (S210).

Here, in a case where each calculation result is specific, the processing unit 210a of the processing device 20a controls the communication unit 230a such that the calculation results respectively obtained in steps S204 and S206 are transmitted to the code issuing device 10 (S212).

Next, the control unit 110 of the code issuing device 10 executes collation based on the process request transmitted in step S202 and each of the calculation results received in step S212 (S214).

Here, in a case where the consistency related to each calculation result is recognized as a result of the collation, the control unit 110 of the code issuing device 10 controls the communication unit 130 such that the collation result indicating that the collation has been completed normally is transmitted to the processing device 20a (S216).

Next, the processing unit 210a of the processing device 20a executes a predetermined subsequent process on the basis of the collation result received in step S216 (S218). In a case where the subsequent process is a registration process for the above-described cooperative operation, the control unit 110 of the code issuing device 10 may also execute the equivalent process.

As described above, the processing unit 210 of the processing device 20 according to the present embodiment may execute a subsequent process in a case where both of a result of a calculation based on a specific constant allocated to the processing device 20 and a result of a calculation based on a specific constant allocated to another processing device 20 are recognized to be valid values.

The processing unit 210 of the processing device 20 according to the present embodiment may execute a subsequent process in a case where both of a result of a calculation based on a specific constant allocated to the processing device 20 and a result of a calculation based on a specific constant allocated to another processing device 20 are recognized to be specific values.

According to the above process flow, in the subsequent process executed by the other successive processing device 20, it is possible to prevent the occurrence of an error or the like related to the above calculation result and thus to more reliably complete a series of processes and also improve processing efficiency.

After the subsequent process in step S218 is completed, the processing unit 210a of the processing device 20a controls the communication unit 230a such that the process request is transmitted to the processing device 20b (S220).

Next, the processing unit 210b of the processing device 20b executes a subsequent process on the basis of the process request received in step S220 (S222).

Next, the processing unit 210b of the processing device 20b controls the communication unit 230b such that a process completion report indicating that the subsequent process executed by the processing device 20b has been completed is transmitted to the processing device 20a (S224).

Next, the processing unit 210a of the processing device 20a controls the communication unit 230a such that the process completion report indicating that the subsequent processes executed by the processing devices 20a and 20b have been completed is transmitted to the code issuing device 10 (S226).

As described above, an example of the process flow in the system 1 according to the present embodiment has been described. In the example illustrated in FIG. 5, the processing device 20a may operate as a master that controls the processing device 20b.

As described above, in the system 1 according to the present embodiment, an information transmission relationship between a plurality of processing devices 20 may take various forms. Thus, various forms may also be taken with respect to which processing device 20 executes calculations based on specific constants allocated to the other processing devices 20.

For example, as illustrated in FIG. 1, a case where the system 1 includes four processing devices 20a to 20d is assumed. In this case, the processing unit 210a of the processing device 20a may perform all calculations based on specific constants respectively allocated to the processing devices 20a to 20d, and determine whether or not each calculation result is a valid value.

On the other hand, for example, the processing unit 210a of the processing device 20a may determine whether or not each of a result of a calculation based on a specific constant allocated to the processing device 20a and a result of a calculation based on a specific constant allocated to at least one processing device 20 among the processing devices 20b to 20d that acquire information from the code issuing device 10 via the processing device 20a according to a data flow is a valid value.

For example, the processing unit 210a of the processing device 20a may determine whether or not each of results of calculations based on specific constants allocated to the processing devices 20a and 20d is a valid value. In this case, the processing unit 210a of the processing device 20a may receive a determination result from the processing device 20b with respect to whether or not each of results of calculations based on specific constants allocated to the processing devices 20b and 20c is a valid value.

For example, the processing unit 210a of the processing device 20a may determine whether or not each of a result of a calculation based on a specific constant allocated to the processing device 20a and a result of a calculation based on a specific constant allocated to the processing device 20b that directly acquires, from the processing device 20a, information from the code issuing device 10 according to a data flow is a valid value.

In this case, the processing unit 210a of the processing device 20a may receive a determination result from the processing device 20b with respect to whether or not each of results of calculations based on specific constants allocated to the processing devices 20c and 20d is a valid value.

As described above, the processing unit 210 of the processing device 20 according to the present embodiment may receive a determination result from at least one other processing device 20 that acquires information from the code issuing device 10 via the processing device 20 according to a data flow.

The processing device 20 that does not directly acquire information from the code issuing device 10 may execute a determination on the basis of the information from the code issuing device 10 that is acquired via another processing device 20, and may transmit a result of the determination to another device via which the information from the code issuing device 10 is acquired.

According to the information transmission, the processing unit 210 of the processing device 20 having received a process request checks whether or not a result of a calculation based on a specific constant allocated to the processing device 20 and all results of calculations based on specific constants allocated to the other processing devices 20 are valid values, and may execute a subsequent process only in a case where all of the respective calculation results are valid.

According to the above process flow, in the subsequent process executed by the other successive processing device 20, it is possible to prevent the occurrence of an error or the like related to the above calculation result and thus to more reliably complete a series of processes and also improve processing efficiency.

### 2. Appendix

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

A series of processes performed by each device described in the present specification may be realized by using any of software, hardware, and a combination of the software and the hardware. A program configuring the software is stored in advance in, for example, a recording medium (non-transitory medium) provided inside or outside each device. Each program is read to a RAM, for example, when the program is executed by a computer, and is executed by a processor such as a CPU. The recording medium is, for example, a magnetic disk, an optical disc, a magnetooptical disc, or a flash memory. The computer program may be distributed via, for example, a network instead of using the recording medium.

What is claimed is:

1. A processing device to which different unique constants are allocated among devices of the same type, the processing device comprising:
a processing unit that performs a calculation based on a common code that is issued by a code issuing device and is used in common by the plurality of processing devices, and the specific constant allocated to the processing device, and executes a subsequent process using a result of the calculation,
wherein, prior to the subsequent process, the processing unit executes a determination of whether or not each of a result of a calculation based on the specific constant allocated to the processing device and a result of a calculation based on the specific constant allocated to at least one other processing device is a valid value.

2. The processing device according to claim 1,
wherein the processing unit executes a determination of whether or not each of the result of the calculation based on the specific constant allocated to the processing device and a result of a calculation based on the specific constant allocated to at least one other processing device that acquires information from the code issuing device via the processing device according to a data flow is a valid value.

3. The processing device according to claim 2,
wherein the processing unit executes a determination of whether or not each of the result of the calculation based on the specific constant allocated to the processing device and a result of a calculation based on the specific constant allocated to at least one other processing device that directly acquires, from the processing device, the information from the code issuing device according to the data flow is a valid value.

4. The processing device according to claim 1,
wherein the processing unit receives a result of the determination from at least one other processing device that acquires information from the code issuing device via the processing device according to the data flow.

5. The processing device according to claim 1,
wherein the processing device operates as a master that controls at least one other processing device that operates as a slave, and
wherein the processing unit of the processing device that operates as a master determines whether or not each of the result of the calculation based on the specific constant allocated to the processing device and a result of a calculation based on the specific constant allocated to the at least one other processing device that operates as a slave is a valid value.

6. The processing device according to claim 1,
wherein the processing unit executes the subsequent process in a case where each of the result of the calculation based on the specific constant allocated to the processing device and all results of calculations based on the specific constants allocated to other processing devices is a valid value.

7. The processing device according to claim 1,
wherein the processing unit executes the subsequent process in a case where each of the result of the calculation based on the specific constant allocated to the processing device and all results of calculations based on the specific constants allocated to other processing devices is a specific value.

8. The processing device according to claim 1,
wherein the subsequent process includes a registration process for performing a cooperative operation between the code issuing device and the processing device.

9. The processing device according to claim 1,
wherein the processing unit executes the determination on the basis of information from the code issuing device that is acquired via another processing device, and transmits a result of the determination to the other processing device via which the information from the code issuing device is acquired.

10. A non-transitory storage medium storing a program causing a computer to function as a processing device to which different unique constants are allocated among devices of the same type, the program causing the processing device to:
realize a processing function of performing a calculation based on a common code that is issued by a code issuing device and is used in common by the plurality of processing devices, and the specific constant allocated to the processing device, and executing a subsequent process using a result of the calculation,
wherein the processing function is a function of, prior to the subsequent process, executing a determination of whether or not each of a result of a calculation based on the specific constant allocated to the processing device and a result of a calculation based on the specific constant allocated to at least one other processing device is a valid value.

11. A system comprising:
a code issuing device that issues a common code that is used in common by a plurality of devices; and
a plurality of processing device that perform a calculation based on the common code and a specific constant allocated to each of devices of the same type and execute a subsequent process using a result of the calculation,
wherein, prior to the subsequent process, at least one of the plurality of processing devices executes a determination of whether or not each of a result of a calculation based on the specific constant allocated to the processing device and a result of a calculation based on the specific constant allocated to at least one other processing device is a valid value.
